(19) United States
(12) Patent Application Publication
(10) Pub. No.: US 2013/0018776 A1
(43) Pub. Date: Jan. 17, 2013

(54) System and Method for Income Risk Assessment Utilizing Income Fraud and Income Estimation Models

(71) Applicants: Jianjun Xie, Poway, CA (US); Hoi-Ming Chi, Poway, CA (US); Roger Noe, Poway, CA (US); Mike Barnett, Poway, CA (US); Brent Gaddis, Poway, CA (US); James Baker, Poway, CA (US)

(72) Inventors: Jianjun Xie, Poway, CA (US); Hoi-Ming Chi, Poway, CA (US); Roger Noe, Poway, CA (US); Mike Barnett, Poway, CA (US); Brent Gaddis, Poway, CA (US); James Baker, Poway, CA (US)

(73) Assignee: First American Way, Poway, CA (US)

(21) Appl. No.: 13/182,228

(22) Filed: Jul. 13, 2011

(51) Int. Cl. G06Q 40/02

(52) U.S. Cl. 705/38

(57) ABSTRACT

A method of income validation and evaluation for income risk assessment is disclosed in one embodiment. The method includes receiving a borrower loan request including a plurality of borrower data selected from the group consisting of: an employment type code, a borrower date-of-birth, a borrower zip code and a stated monthly income. The method further includes analyzing the received plurality of borrower data with respect to a stored plurality of borrower data to generate a normalized plurality of borrower data, implementing, if the stated monthly income is non-zero, an income fraud model utilizing at least the normalized plurality of borrower data including the employment type code, the borrower date-of-birth and the borrower zip code to determine an income fraud score based on the normalized plurality of borrower data, implementing an income estimation model utilizing at least the normalized plurality of borrower data and an age-band to determine a predicted income, and determining a risk assessment value as a function of the income fraud model and the income estimation mode.

### TECHNICAL FIELD

This patent relates to a system and method for quantifying and analyzing the income risk based on loan application data, and in particular a system and method for income risk analysis utilizing an income fraud model and an income estimation model to determine a risk indicator based on an assessment of the specific loan application data with respect to an aggregate of loan application data and information for similarly situated loan applicants.

### BACKGROUND

Loan applications typically represent a first step or requirement in obtaining the financing necessary to secure a loan for the purchase of a house, a piece of property or other asset. The loan application requires an applicant to collect and provide the information a lender needs to approve the loan. Often times the task of collecting this information can be difficult for both experienced and inexperienced loan applicants. For instance, loan applicants may be unfamiliar with the financial terminology used throughout a loan application which increases the likelihood of an error. Alternatively, a loan applicant may provide incorrect or incomplete information in an attempt to borrow more money than their financial situation warrants. Regardless of the source of the error, loan processors and originators must evaluate the provided and available information in making their loan determination. Present tools and systems for the evaluating and assigning income risk in light of these sources of error have proven insufficiently accurate. Consequently, loan processors and originators have endured greater income risk and uncertainty when loaning and/or investing money based on the scores and indications provided by the present tools and systems for the evaluating and assigning risk.

### SUMMARY

The disclosed methods and system provide a tool for analyzing received borrower income data with respect to similar borrower income data to generate a normalized set of borrower data. The normalized set of borrower income data can then be utilized by the tool and/or module in connection with an income fraud model that determines a fraud score associated with the borrower application. The normalized data can further be utilized by the tool to generate an estimated or predicted income based on the provided borrower data with respect to borrower data associated with similarly situated borrowers, individuals and groups. The disclosed tool outputs a risk assessment value and indicator based on the fraud score with or without the estimated income.

A method of income validation and evaluation for income risk assessment is disclosed in one embodiment. The method includes receiving a borrower loan request including a plurality of borrower data selected from the group consisting of: an employment type code, a borrower date-of-birth, a borrower zip code and a stated monthly income. The method further includes: analyzing the received plurality of borrower data with respect to a stored plurality of borrower data to generate a normalized plurality of borrower data; implementing, if the stated monthly income is non-zero, an income fraud model utilizing at least the normalized plurality of borrower data including the employment type code, the borrower date-of-birth and the borrower zip code to determine an income fraud score based on the normalized plurality of borrower data; implementing an income estimation model utilizing at least the normalized plurality of borrower data and an age-band to determine a predicted income; and determining a risk assessment value as a function of the income fraud model and the income estimation mode.

A system of income validation and evaluation for income risk assessment is further disclosed. The system includes a computer-processor in communication with a memory device, wherein the memory device is configured to store computer-processor executable instructions to: store a borrower loan request in at least a portion of the memory device, wherein the borrower loan request includes a plurality of borrower data selected from the group consisting of: an employment type code, a borrower date-of-birth, a borrower zip code, an age-band and a stated monthly income; standardize the plurality of borrower data with respect to an aggregate plurality of borrower data stored in at least a second portion of the memory device; implement an income fraud model utilizing at least the standardized plurality of borrower data to determine an income fraud score; implement an income estimation model utilizing at least the standardized plurality of borrower data to determine a predicted income as a function of at least the age band; and determine a risk assessment value as a function of the income fraud model and the income estimation mode.

A second method of income validation and evaluation for income risk assessment is disclosed in another embodiment. The method includes analyzing a received plurality of borrower data with respect to a stored plurality of borrower data to generate a normalized plurality of borrower data, wherein the received plurality of borrower data includes a plurality of borrower data selected from the group consisting of: an employment type code, a borrower date-of-birth, a borrower zip code and a stated monthly income, implementing, if the stated monthly income is non-zero, an income fraud model utilizing at least the normalized plurality of borrower data to determine an income fraud score based on the normalized plurality of borrower data, implementing an income estimation model utilizing at least the normalized plurality of borrower data and an age-band to determine a predicted income, and determining a risk assessment value as a function of the income fraud model and the income estimation mode.

Other embodiments are disclosed, and each of the embodiments can be used alone or together in combination. Additional features and advantages of the disclosed embodiments are described in, and will be apparent from, the following Detailed Description and the figures.

### BRIEF DESCRIPTION OF THE FIGURES

FIG. 1 is an exemplary income risk assessment report that may be generated by the income validation and evaluation process and tool disclosed herein;

FIG. 2 illustrates an embodiment of a system and configuration that may be implemented to generate the income risk assessment report referred to and shown in FIG. 1;

FIG. 3 is a flow chart showing the overall income validation and evaluation process for a single request;

FIG. 4 is a flow chart showing the execution of the fraud score model incorporated in the income validation and evaluation process; and

FIG. 5 is a flow chart showing the execution of the income prediction model incorporated in the income validation and evaluation process.

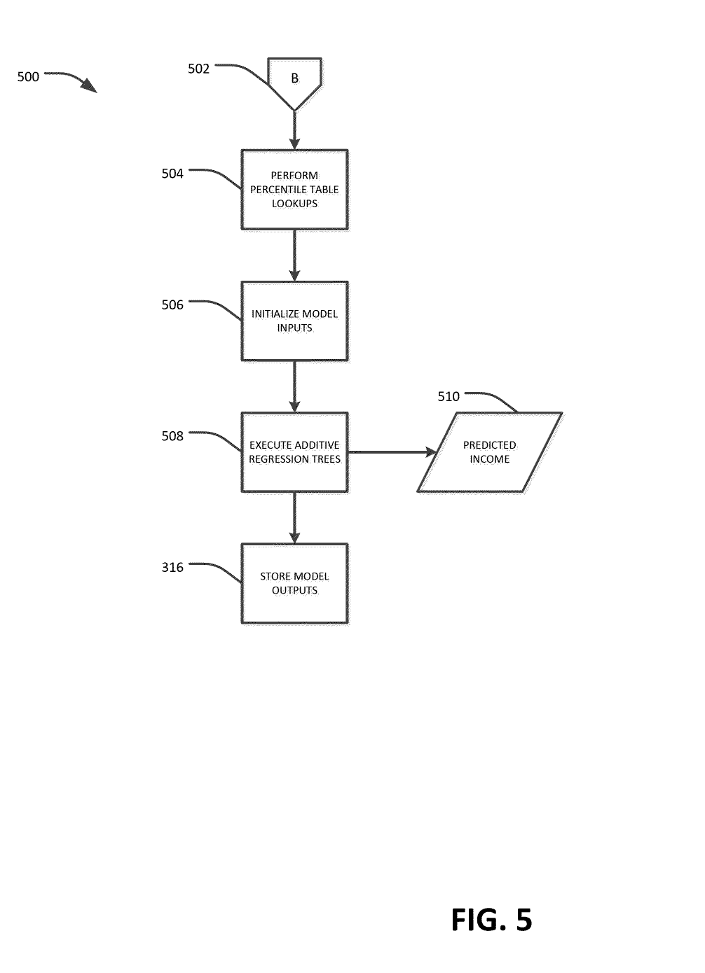

### DETAILED DESCRIPTION

The disclosed tool for income validation and evaluation addresses the limitations of known income risk assessment tools. Moreover, the disclosed tool provides a mechanism that reduces losses from income fraud or misrepresentation. This reduced loss, in turn, saves the costs (in terms of both the monetary costs and the man-hour costs) of processing a default loan, acquiring the underlying asset via a foreclosure, and implementing other courses of action such as a buyback, a repossession or a charge-off. The disclosed tool replaces the inefficient and expensive known income risk assessment tools with the disclosed tool for income validation and evaluation that utilizes current income validation (i.e., real-time or near real-time) data and sources to insure that the resulting assessment is based on the most up-to-date information available. Because the disclosed tool for income validation and evaluation utilizes the most up-to-date information available, the disclosed tool provides a valuable resource for conducting real-time income risk assessments for auto and credit card loans. Moreover, disclosed tool for income validation and evaluation provides a valuable resource for compliance with regulatory schemes intended to promote lending accountability and consumer protection.

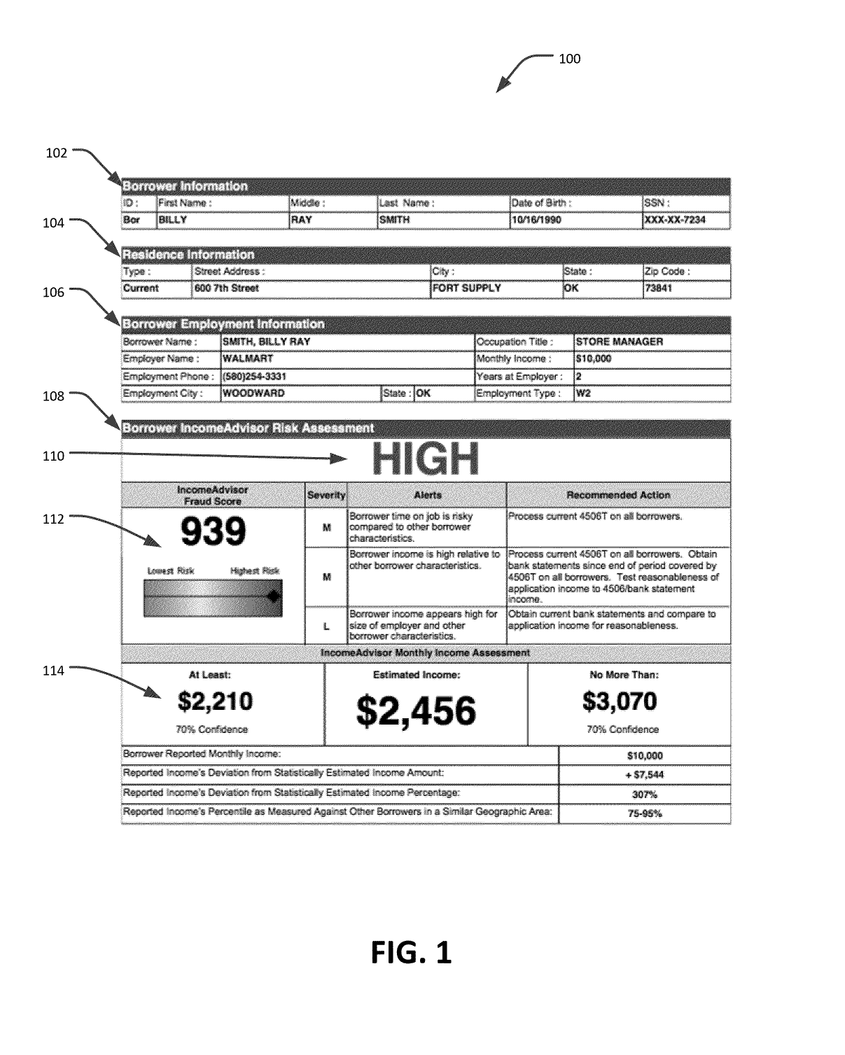

FIG. 1 illustrates an example of an income risk assessment report 100 that may be generated based on the disclosed tool for income validation and evaluation. The illustrated report 100 is intended to provide an example of the information that may be gathered, organized and analyzed by the disclosed tool to provide an accurate income risk assessment. The specific format and content of the report 100 may be revised while still providing relevant and timely income risk assessment information. For example, the exemplary income risk assessment report 100 may include specific applicant or borrower information 102 such as the borrower's full name, date of birth (DOB) and social security number (SSN) or other unique identifier number. This specific borrower information 102 serves to uniquely identify the person to which the income risk assessment report 100 pertains. The specific borrower information 102 may be supplemented by residence information 104 that identifies the current residence, and if desired the past residences, occupied or associated with the applicant or borrower.

The exemplary income risk assessment report 100 further includes applicant or borrower employment information 106. The borrower information 106 provides a quick reference of the applicant's current employment situation such as their position, length of employment, employment location as well as their employment type. This employment information 106 is, in turn, utilized by the exemplary income validation and evaluation methods and system to determine an overall or aggregate income assessment 110.

The overall income assessment 110 is based on an income fraud evaluation 112 and a predicted income estimation 114. The income fraud evaluation 112, in this exemplary embodiment, predicts the likelihood that the income asserted by the applicant is accurate based on, for example, their employment information, geographic location, etc. Similarly, the predicted income estimation 114 is based on an evaluation of the applicant's provided employment information with respect to the employment and income information of similarly situated applicants or borrowers.

In this way, the exemplary income risk assessment report 100 provides a fast and accurate mechanism by which the credit-worthiness of an applicant can be evaluated. In particular, the income fraud evaluation 112 and the predicted income estimation 114 provided by the risk assessment report 100 allow loan originators and lenders to quickly evaluate an applicant's income and information based on the generated overall income assessment 110.

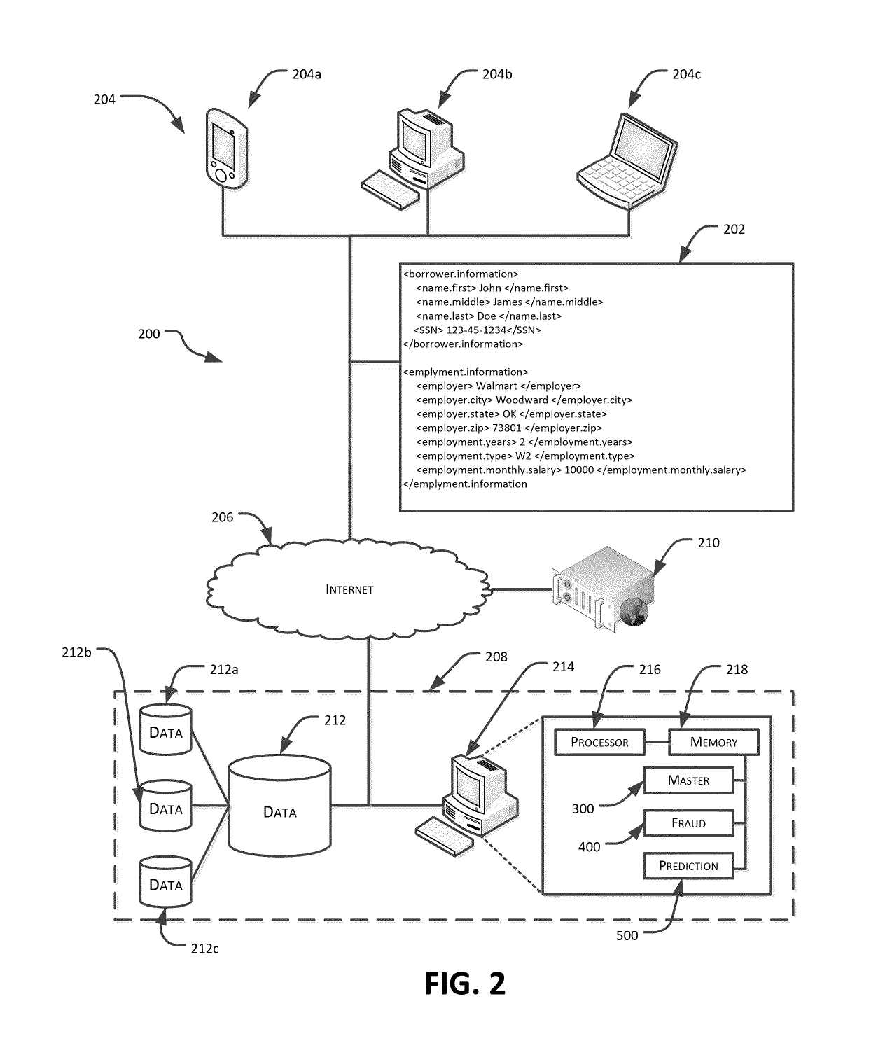

The disclosed tool for income validation and evaluation may be implemented by the exemplary risk assessment and income evaluation system 200 shown in FIG. 2. Generally, the income evaluation system 200 is configured to gather borrower information 202 from one or more client input devices 204. The gathered borrower information 202 may be communicated via a wired or wireless network 206 to the disclosed tool for income validation and evaluation 208.

The network 206 may be a wide area network (WAN) such as the Internet or a local area network (LAN) such as an intranet. Alternatively, the network could include a combination of by a WAN and a LAN in communication with each other. The network 206 may communicate according to known TCP/IP protocols, IEEE wireless protocols such as 802.11X or any other known or contemplated networking standard.

Client input devices 204 may be a personal digital assistant 204a, a personal computer 204b, a laptop computer 204c or any other device capable of receiving and/or communicating applicant or borrower information 202. In an embodiment, the client input devices could include a scanner and optical character recognition (OCR) software configured to extract the borrower information from an image of a scanned hardcopy document. The extracted borrower information may then be converted to a format usable by the income evaluation system 200.

In another embodiment, the applicant or borrower information 202 may be collected and formatted utilizing a client application executable on one of the client input devices 204. Formatting of the applicant or borrower information 202 may include converting the collected information into a structured data format such as extensible markup language (XML). The borrower information 202 shown in FIG. 2 provides an exemplary XML request or message. The exemplary XML request includes the structured data values necessary to populate the borrower information 102 and borrower employment information 106 portions of the exemplary income risk assessment report 100 shown in FIG. 1.

Alternatively, a webserver 210 may be configured to host and serve a graphical user interface (GUI) such as an application interface. The application interface is accessible via a browser such as MICROSOFT® INTERNET EXPLORER® and APPLE® SAFARI® operable on one of the client input devices 204. The webserver 210 can provide or store one or more downloadable JAVA® programs or applets written in the Java programming language to facilitate interaction and information collection with the applicant. For example, the webserver 210 may provide a secure mechanism by which the tool for income validation and evaluation 208 can share information with the client input devices 204. An applet provided by the webserver 210 may facilitate establishing a virtual private network (VPN) between the client devices 204 and the tool for income validation and evaluation 208.

The tool for income validation and evaluation 208 may be an application specific device that includes both the hardware and software components necessary to operate the exemplary risk assessment and income evaluation system 200. In another configuration, the tool 208 may be a distributed network components configured to share information and resources in the implementation of the exemplary risk assessment and income evaluation system 200. For example, the tool 208 may include a database or storage 212 that can be configured to store the collected borrower data received via the client devices 204. The database 212 may further store borrower data and information for loan applications originating across the geographic and demographic spectrum of applications. This large store of borrower data and information for loan applications represents a compendium of loan and borrower knowledge and information. This compendium may be augmented by the information from publicly accessible sources such as a federal employment database 212a, a local or state income tax database 212b, and/or private sources such as a private credit database or 212c.

For example, the tool 208 may further include a controller 214 such as a personal computer programmed to perform the specific tasks and analyses for income validation and evaluation. In another embodiment, the controller 214 may be a process specific device configured to store non-transitory instructions for implementing income validation and evaluation. The controller 214 may include a processor 216 in communication with a memory 218. The memory 218, in turn, stores the instructions and executable code to perform an income validation and evaluation process 300 that includes a fraud score modeling process 400 and an income prediction modeling process 500.

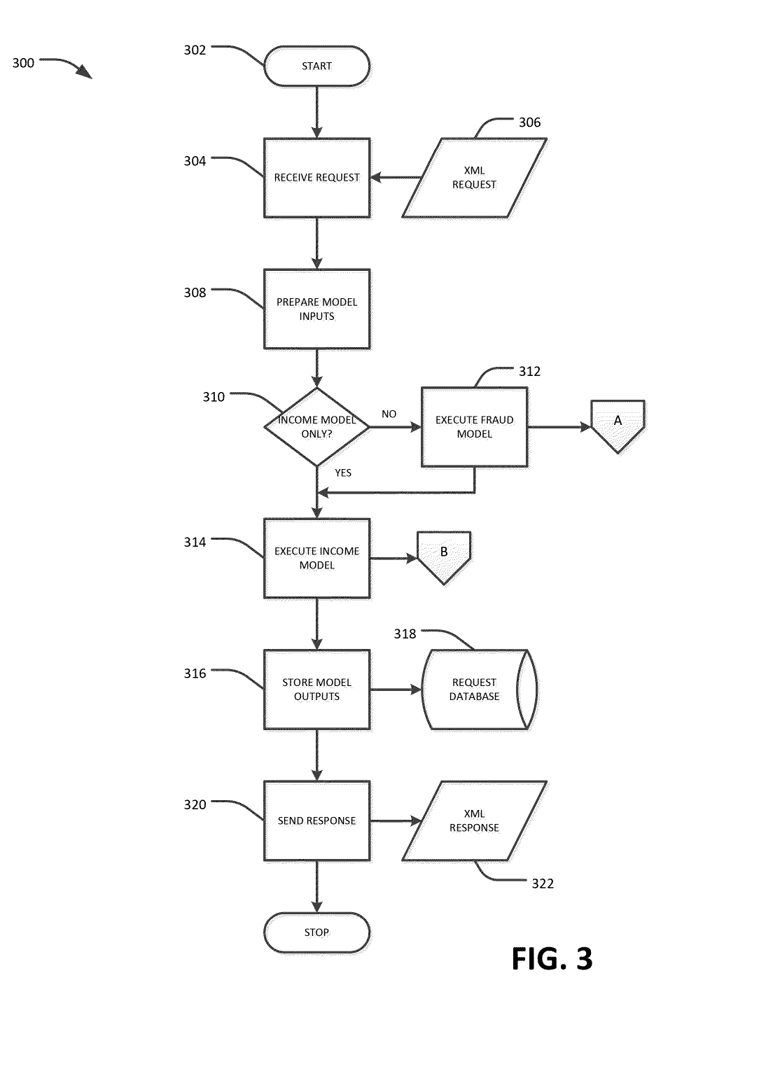

The disclosed tool 208 implements the income validation and evaluation process 300 as disclosed in the exemplary process detailed in FIG. 3. The tool 208 begins the income evaluation process 300 by initializing the data structures and reading data tables from files stored in the database 212 and/or the memory 218 (see block 302). As used herein, references or descriptions directed to stored information, loan application data, borrower information or the like are intended to refer to data and information stored in accessible data tables defined in the database 212 and/or memory 218. Initialization of data structures includes setting default values for data structures as defined by the contents of an application properties file stored in the memory 218.

The tool 208 receives a request for income validation and evaluation (block 304) of an applicant from an application or applet executing on one of the client input devices 204. Alternatively, the request may be initiated or communicated by a servlet executing on the webserver 210. As previously discussed, the data provided with the request may be formatted as an XML message or request such as the borrower information 202 shown in FIG. 2. The individual data values and strings are, in turn, extracted from borrower data contained in the XML request (block 306).

The data contained in the XML request includes borrower information 202 such as: a processing identifier (ID), the loan application date, the borrower's date of birth, an employment type code, a mailing address (including zip code), an employer's name and address (including zip code), borrower's job title, a stated total monthly income, a number of years in current position, a number of year in current profession. Additional information and data may be provided with the XML request but is not required for the income evaluation process 300 to operate.

The tool 208 and the income evaluation process 300, upon receiving and extracting the borrower data 202, preprocesses and analyzes the provided borrower information for completeness (block 308). If necessary, the provided borrower information can be modified to fill in any gaps in the borrower information. For example, if the tool determines that an XML request includes an undefined processing ID or a missing mailing address zip code, a critical error is generated that aborts further processing. The tool 208 calculates the borrower's age as the difference between the provided date of birth and loan application date. The borrower's age is retained in two forms: (1) the calculated age and (2) a 5-year age band that represents the greatest multiple of 5 years that does not exceed the calculated age.

The tool 208 evaluates the employment type code to determine if a valid code has been provided. Valid employment type codes include: (1) W-2 or salaried employee; (2) self-employed or owner; or (3) not employed, student, retired. If the tool determines that the employment type code has been omitted, a default employment type code may be specified. For example, the default employment type code could correspond to the W-2 or salaried employee. In this example, the default employment type code would, in turn, correspond to a numerical value of one (1).

The mailing address and employer address zip codes are preprocessed to remove non-numeric digits. A full five (5) digit version of the zip code and a first three (3) digit version are subsequently retained in the memory 218 and/or database 212. These two versions are individually identified and stored within the variables identified as zip5 and zip3. The zip5 and zip3 variables can, in turn, be used to search for, and sort details within, the compendium of loan and borrower information stored in the database 212. Specifically, the zip code information stored within the zip5 and zip3 variables allow the compendium of loan and borrower information to be searched based on the geographic location or region of the applicants and/or the applicant's employer.

If the tool 208 or income evaluation process 300 determines that one or more piece of the borrower information provided in the XML request is missing, then the determined null value is replaced with a default value. The default value may be determined based on the processing ID (PROC_ID) associated with the XML request. In operation, the tool 208 utilizes a table containing every recognized processing ID and all of the configurable parameters associated with an individual client. Examples of these configurable parameters include: default values for missing borrower information, configurable thresholds for identifying different risk levels associated with fraud scores, and income estimates. In this way, the tool 208 utilizes the processing ID as an index into the table of configurable parameters. Once accessed via a table look-up, the resulting information and data can be utilized to set each configurable parameter.

The tool 208 and income evaluation process 300 further analyzes both the job title and the employer name to correct common misspellings and remove extraneous punctuation. Common abbreviations and acronyms are expanded to full words and common company type words/abbreviations are removed. For instance, elements such as “Inc.”, “Corp.”, “LLC”, “LLP”, “LTD” and the like are removed, and job titles such as “Mgr.” and “Engr.” are replaced and expanded with “Manager” and “Engineer”, respectively.

If, at block 310, the tool determines the stated total monthly income is a null value (i.e., no monthly income was provided in the XML request), the fraud score modeling process 400 is not executed and the income evaluation process 300 simply executes the income prediction modeling process 500 (at block 314). In cases where the fraud score modeling process 400 is not utilized, the XML request is considered to be an income model only request. In these instances, the fraud model outputs (fraud score and risk indicators) are replaced with “N/A”. Similarly, other outputs derived from the total income or the fraud model outputs are then also replaced with “N/A”.

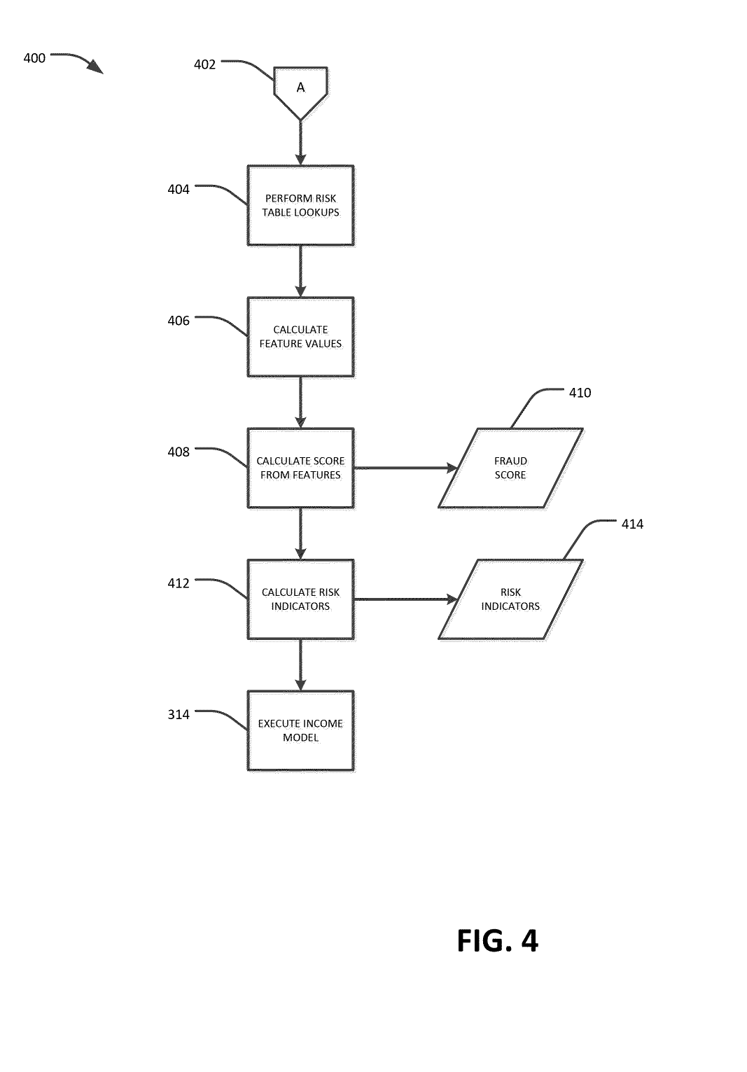

If, however, the stated total monthly income is a non-zero value, then the income evaluation process 300 executes the fraud score modeling process 400 (block 312). Turning to FIG. 4, the fraud score modeling process 400 initiates (at block 402) by retrieving some or all of the preprocessed borrower information (from block 308). The retrieved borrower information includes the calculated borrower's age, 5-year band age, the number of years the borrower has been in their current position, the borrower's stated total monthly income, employer name, employment type code, and mailing address zip code (both zip5 and zip3).

Subsequently, the fraud score modeling process 400 queries one or more databases 212 based on the employment type (EMP_TYPE) code, the mailing address zip code (both zip5 and zip3), and the borrower's 5-year band age (see block 404). For example, a query based on EMP_TYPE and zip (either zip5 or zip3) or EMP_TYPE the 5-year age may be implemented to determine an income average percentile based on the combo of EMP_TYPE and zip/age. If, in one embodiment, the employment type code indicated “W-2 employee” (1) and the 5-year band age was 40, these would be concatenated to form a joint key, “1_{—}40”. The joint key can, in turn, be used as the index into a table to look up several data items associated with this particular combination of employment type code and 5-year band age.

The query results are utilized by the fraud score modeling process 400 to determine income percentile values for a given employment type code according to the borrower's geographic location. For example, the above discussed joint key “1_{—}40” might correspond to a 75^{th} percentile income value for all those with the “W-2 employee” employment type code and 5-year band age of 40. The numeric value, expressed as a monthly total income at the 75^{th} percentile of this group, would be contained within the table and returned by the query.

The geographic location is determined based on the zip5 value if available or the zip3 value if necessary. If neither zip5 nor zip3 appear in the table, the income percentile values are based on national averages as opposed to geographically-specific averages. In this manner, the fraud score modeling process 400 determines, based on the borrower's provided employment information and location, a range of income reported by other borrowers in similar positions and careers. The borrower's stated monthly income can then be evaluated against a range of incomes reported by similarly situated borrowers. As previously discussed, the range of incomes and other information related to similarly situated borrowers is stored and accessible via the compendium of borrower information contained within the database 212. This comparison allows a loan originator or processor to determine if the stated monthly income represents an outlier and therefore presents a greater risk of default.

Utilizing the information gathered via the queries to the database 212 (or the associated and accessible databases 212a to 212c), the fraud score modeling process 400 determines a pool of feature variable values based on the retrieved borrower information and risk table lookups (see block 406). The pool of feature variables fall into three broad categories: (1) attributes derived from the application information such as the ratio of income to professional years of the borrower; (2) attributes dependent on percentile tables such as the 75^{th} income percentile based on professional years; and (3) risk rates based on risk table lookups for certain key attributes which could be based on the professional years.

The group of feature variables utilized by the fraud score modeling process 400 may by selected based on their predictiveness with respect to identifying an income misrepresentation. Selection of the feature variable may be accomplished via any number of statistical feature selection methods such as a stepwise selection method, a correlation selection method, one or more entropy-based selection methods and/or and information gain selection. This is to avoid overfitting and achieve better generalization on future unseen data.

Once the feature variables and any associated variables have been determined, the fraud score modeling process 400 calculates a fraud score (at block 408) based on the determined values. The fraud score is determined by the equation:

$$Score = Floor ( 999.5 * \frac{Raw\_Probability}{\begin{matrix}Raw\_Probability + ( Prior * \frac{\# Bad}{\# Good} ) * \\ ( 1 - Raw\_Probability )\end{matrix}} ) ,$$

where # Bad and # Good, as the names suggest, are the number of bad and good examples in the training data (which is usually sampled), and where Prior is the good to bad ratio of the unsampled data. The raw probability of fraud is estimated by any suitable statistical modeling technique including, for example, neural networks, support vector machines (SVM), naïve Bayesian, logistic regression and/or decision trees.

At block 410, the fraud score modeling process 400 calculates the fraud score. A higher score indicates a greater probability of fraud. The fraud score is one of the outputs of fraud score modeling process 400. The fraud score is then scaled to a value from 1 to 999.

The fraud score modeling process 400 (at block 412) examines each of the calculated feature variable values to determine if the feature variable value warrants activation of a risk indicator. In the case of logistic regression, each feature variable value is multiplied by a corresponding weight to assess the feature's overall impact on the fraud score. Only those features having a variable value exceeding a specified threshold will trigger a risk indicator. Thresholds are established to ensure that for any high scoring loans, a fixed number of risk indicators will be triggered. Risk indicators are triggered when the product of its feature value and weight exceed the pre-defined threshold. Triggered risk indicators are then sorted into priority order.

Income risk indicators consist of a risk indicator identifier, a severity value (low, medium or high), a brief description of the risk, and a recommended action for mitigation of the potential income risk. The resultant prioritized set of risk indicators are also an output of the fraud score modeling process 400 (see block 414). Upon completion of this function, the fraud score modeling process 400 returns to block 314 of process 300 (shown in FIG. 3).

At block 314 of income evaluation process 300, the income prediction modeling process 500 (at block 314) executes regardless of whether or not the fraud score modeling process 400 has executed. As the process 500 activates, the preprocessed (from block 308) borrower information is retrieved (see block 502). The preprocessed information utilized in connection with the income prediction modeling process 500 includes the borrower's 5-year band age, number of years in the current job, employer name, employment type code, job title, and mailing address zip code (both zip5 and zip3).

The income prediction modeling process 500, after initialization of the preprocessed information discussed in connection with block 308, executes a series of percentile comparisons (see block 504) of the current borrowers information with respect to an aggregate collection of borrower data stored in the database 112. Examples of the queries are the borrower's employer name, the job title, previous loan application income and employment related information. For example, if a borrower's job title is “software engineer”, the query returns a monthly income distribution at 5^{th}, 25^{th}, 50^{th}, 75^{th}, 95^{th} and 99^{th} percentile aggregated from the historical income values for “software engineer”.

The income prediction modeling process 500 calculates and evaluates a number of predictive variable values based on the percentile comparisons and the received preprocessed borrower information (see block 506). These percentile comparisons provide a mechanism by which the specific borrower information and values can be evaluated against information and values of all similarly situated borrowers. In other words, the percentile comparisons can illustrate if the specific borrower information is an outlier with respect to the aggregated borrower information stored in the database 212.

The predictive variables fall into two broad categories: (a) attributes derived from the application information and (b) income distributions based on percentile table lookups for certain key attributes. All of these predictive variables are used to produce a predicted monthly income through various statistical techniques such as but not limited to multiple additive regression trees, linear regression, and/or piece wise regression. Examples of predictive variables include job years and employment type in category (a) and 95th percentile of income distribution of job title in category (b). The income prediction modeling process 500 executes the regression model utilizing the calculated predictive variables as inputs (block 508). The result of the regression model is the predicted monthly income (block 510).

Upon calculating the predicted monthly income, the process returns to the income evaluation process 300 shown in FIG. 3. The fraud score received from the fraud score modeling process 400 and the predicted income received from the income prediction modeling process 500 are stored in the memory 218 or the database 212 (at block 316). At this point, secondary output values are calculated in preparation for storing the results in the database 212. The secondary output values, in an exemplary embodiment, represent a range of monthly incomes that may occur with a 70% confidence. For example, the secondary output values may be calculated as a range where the lower limit is 90% of the predicted monthly income and the upper range is 125% of the predicted monthly income.

The confidence interval as well as the default positive and negative income variance values are stored in the database 212 according to the processing ID of the XML request. These income variance values may be defined to correspond with any desired confidence interval or range. These secondary output values and the associated range provide a measure of likelihood that the actual income is no greater than the high-predicted income and no less than the low-predicted income.

Except for the case of an income model only request (block 310), the next step is to determine the income deviation amount and percent. The deviation amount is calculated as the difference between the input total monthly income provided in the borrower information 202 and the predicted income received from the income prediction modeling process 500. The deviation percent is calculated as the portion of the predicted income equal to the deviation amount. For an income model only request, the deviation amount and percent are replaced with “N/A”.

The income evaluation process 300 obtains the income confidence value by querying the database 212. The income confidence value is determined and based on statistical analysis of historical values.

Except for the case of an income estimation model only request (see block 310), the income evaluation process 300 next step is to determine the overall income assessment 110. As generally indicated in the report 100, the overall income assessment 110 is defined based on one of three income risk categories—high, medium, or low. These income risk categories are determined for the fraud score and the income deviation percent and the overall income confidence value determined from the database 212. For each of these three determinations, the high/medium and medium/low boundary values may be accessed from the database based on the processing ID of the request. The specific combination of the fraud score risk category, the income deviation percent risk category, and the overall income confidence risk category is then used as a key for another table lookup according to the processing ID of the request. Thus, there are 3³=27 entries in this table for each processing ID, corresponding to the combinations of high, medium, and low risk categories for each of the 3 data items. The result of this table lookup is again a risk category—high, medium, or low—that is assigned as the overall risk assessment for the request. For example, if the borrower's fraud score is 900, the income deviation between stated and predicted is 80%, the income prediction confidence is 75%, then the overall risk assessment will be in “High” category. For an income model only request, the overall risk assessment is replaced with “N/A”.

The final derived output data value is the income percentile range. This is obtained as the result of a table lookup of the total monthly income input value according to the mailing address zip code and employment type code. For an income model only request, the income percentile range is replaced with “N/A”.

The foregoing preprocessed input values, model output values, and secondary derived output values are next inserted into a request database portion of the database 212. The results and data from the request database may be stored for long term analysis of the processes 300, 400 and 500 based on the recorded results and the previously determined risk assessment. This information may be utilized to modify the fraud and income models discussed in connection with the processes 400 and 500, respectively.

The overall income assessment 110 information and output values the processes 300, 400 and 500 are combined and organized into an XML message (see block 320). The correlated and assembled XML message forms an XML response (block 322) that includes at least some of the borrower information 202 communicated in the XML request. The XML response is sent to the requesting client device 204 via the server 210 and/or the network 206

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A method of income validation and evaluation for income risk assessment, the method comprising:
receiving a borrower loan request including a plurality of borrower data selected from the group consisting of: an employment type code, a borrower date-of-birth, a borrower zip code and a stated monthly income;
analyzing the received plurality of borrower data with respect to a stored plurality of borrower data to generate a normalized plurality of borrower data;
implementing, if the stated monthly income is non-zero, an income fraud model utilizing at least the normalized plurality of borrower data including the employment type code, the borrower date-of-birth and the borrower zip code to determine an income fraud score based on the normalized plurality of borrower data;
implementing an income estimation model utilizing at least the normalized plurality of borrower data and an age-band to determine a predicted income; and
determining a risk assessment value as a function of the income fraud model and the income estimation mode.

2. The method of claim 1, wherein the risk assessment value comprises a high risk value, a medium risk value and a low risk value.

3. The method of claim 1, wherein the received borrower loan request is provided in a structured data format.

4. The method of claim 1, wherein the age-band is a five (5) year age range determined to no exceed the borrower date-of-birth.

5. The method of claim 1 further comprising:
determining, if the stated monthly income is non-zero, an income deviation as the difference between the predicted income and the stated monthly income.

6. The method of claim 1 further comprising:
determining a confidence interval based on the normalized plurality of borrower data.

7. The method of claim 7, wherein the normalized plurality of borrower data include a job title.

8. The method of claim 7, wherein determining a risk assessment value further comprises determining a risk assessment value as a function of the confidence interval.

9. A system of income validation and evaluation for income risk assessment, the system comprising:
a computer-processor in communication with a memory device, wherein the memory device is configured to store computer-processor executable instructions to:
store a borrower loan request in at least a portion of the memory device, wherein the borrower loan request includes a plurality of borrower data selected from the group consisting of: an employment type code, a borrower date-of-birth, a borrower zip code, an age-band and a stated monthly income;
standardize the plurality of borrower data with respect to an aggregate plurality of borrower data stored in at least a second portion of the memory device;
implement an income fraud model utilizing at least the standardized plurality of borrower data to determine an income fraud score;
implement an income estimation model utilizing at least the standardized plurality of borrower data to determine a predicted income as a function of at least the age band; and
determine a risk assessment value as a function of the income fraud model and the income estimation mode.

10. The system of claim 9, wherein the income fraud model is implemented when the stated monthly income is determined to be a non-zero value.

11. The system of claim 9, wherein the risk assessment value represents one of: a high risk category, a medium risk category and a low risk category.

12. The system of claim 9, wherein the borrower loan request is received via a communication module in communication with the computer-processor and the memory device.

13. The system of claim 12 wherein the borrower loan request is provided in a structured data format.

14. The system of claim 9, wherein the predicted income is determined as a function of the age-band.

15. The system of claim 9, wherein the age-band is a five (5) year age range determined to no exceed the borrower date-of-birth.

16. The system of claim 9, wherein the memory device is further configured to store computer-processor executable instructions to further comprising:
determine, if the stated monthly income is non-zero, an income deviation as the difference between the predicted income and the stated monthly income.

17. The system of claim 9, wherein the memory device is further configured to store computer-processor executable instructions to further comprising:
determine a confidence interval based on the normalized plurality of borrower data.

18. A method of income validation and evaluation for income risk assessment, the method comprising:
analyzing a received plurality of borrower data with respect to a stored plurality of borrower data to generate a normalized plurality of borrower data,
wherein the received plurality of borrower data includes a plurality of borrower data selected from the group consisting of: an employment type code, a borrower date-of-birth, a borrower zip code and a stated monthly income;
implementing, if the stated monthly income is non-zero, an income fraud model utilizing at least the normalized plurality of borrower data to determine an income fraud score based on the normalized plurality of borrower data;
implementing an income estimation model utilizing at least the normalized plurality of borrower data and an age-band to determine a predicted income; and
determining a risk assessment value as a function of the income fraud model and the income estimation mode.

19. The method of claim 18, wherein the risk assessment value comprises a high risk category, a medium risk category and a low risk category.

20. The method of claim 18, wherein the age-band is a five (5) year age range determined to not exceed the borrower date-of-birth.
